(19) United States
(12) Patent Application Publication
(10) Pub. No.: US 2011/0203368 A1
(43) Pub. Date: Aug. 25, 2011

(54) SPECIAL MEASURING BOTTLE FOR MEASURING VOLUME OF SOLID

(76) Inventors: Han-Rong ZHANG, Taipei City (TW); Chia-Jung Hu, Taipei City (TW)

(21) Appl. No.: 12/709,398

(22) Filed: Feb. 19, 2010

(51) Int. Cl. G01F 19/00

(52) U.S. Cl. 73/426

(57) ABSTRACT

A special measuring bottle for measuring volume of solid includes a bottle body and a lid body. The bottle body is filled with a liquid and has an accommodating cavity to be accommodated with a sample solid and a reading cavity communicating with the accommodating cavity. The size of the inner edge of the accommodating cavity is larger than that of the reading cavity. Meanwhile, the accommodating cavity is formed an opening, and the reading cavity is arranged a plurality of graduations available for reading the level position of liquid. The lid body is sealed at the opening just like a shroud. Thereby, when the volume of a solid is measured by the displacing method, the accuracy of measurement by the special measuring bottle is higher than that by a common graduate of close volume, and by the special measuring bottle the specific weight of the sample solid can be less than that of the adapted liquid.

### BACKGROUND OF THE INVENTION

1. Field of the Invention

The present invention in general relates to a device for measuring volume, in particular, to a special measuring bottle for measuring volume of solid.

2. Description of Prior Art

Graduate is a measuring device mainly adapted for measuring volume of liquid. Outer appearance of common graduate is shown as a cylindrical vertical long shape, the bottom part of which is arranged a base to maintain stable condition, so the graduate is not easily tilted and fallen, when erected. Meanwhile, the wall of the graduate has graduation (scale) for reading the volume. Common graduate is the most convenient container accessible for measuring liquid, if the measurement needs not to be very accurate.

Graduate can also be used for measuring the volume of solid with complex shape. The measuring method is displacing method which applies the principle that the volume of the solid immersed into the liquid is equal to the volume of the liquid that the solid displaces. According to this method, the graduate is first filled with liquid, such as water usually. Then, the graduation which the water level reaches is read as a reference value. Next, the solid is immersed into the water, and hence lifts the water level. At this time, the graduation which the lifted water level reaches is read as a total value. The volume of the solid can be determined by deducting the reference value from the total value. However, if the size of the solid is larger than the diameter of tube, the solid can not be placed into the graduate to process a measurement of volume. On the other hand, if a graduate with larger diameter is used instead for the purpose that the solid can be placed therein, the accuracy of measurement will be thereby reduced.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide a special graduate for measuring volume of solid, by which a solid with large size can be placed therein without sacrificing high accuracy of measurement.

Secondly, the invention is to provide a special measuring bottle for measuring volume of solid, including a bottle body and a lid body. The bottle body is provided to be filled with a liquid and has an accommodating cavity which can accommodate the sample solid and a reading cavity communicating with the accommodating cavity. The size of the inner edge of the accommodating cavity is larger than that of the reading cavity. Meanwhile, the accommodating cavity has an opening, and the reading cavity has graduation (scale) for reading the level position of the liquid. The lid body is sealed at the opening just like a shroud.

Compared with the prior arts, the invention has following merits. For one thing, the accommodating cavity can accommodate the sample solid as well as a considerable amount of liquid and the opening has sufficient sizes to let the solid pass through and placed therein while the liquid level in the reading cavity can react sensitively; that is to say, compared with the common graduate of close volume, higher accuracy can be achieved by the invention. For another thing, by the invention, even if the sample solid has lower density than the liquid, the measurement is correct.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is a perspective explosive view according to the present invention;

FIG. 2 is a perspective assembled view according to the present invention;

FIG. 3 is a cross-sectional and locally enlarging view according to the present invention, which has been assembled;

FIG. 4 is an illustration showing how to set a reference point of the present invention;

FIG. 5 is an illustration showing a solid that is being placed into the present invention;

FIG. 6 is an illustration showing that the invention is adapted for measuring the volume of a solid; and

FIG. 7 is a side view of another embodiment according to the present invention.

### DETAILED DESCRIPTION OF THE INVENTION

In cooperation with attached drawings, the technical contents and detailed description of the present invention are described thereinafter according to a number of preferable embodiments, which are not used to limit its executing scope. Any equivalent variation and modification made according to appended claims is all covered by the claims claimed by the present invention.

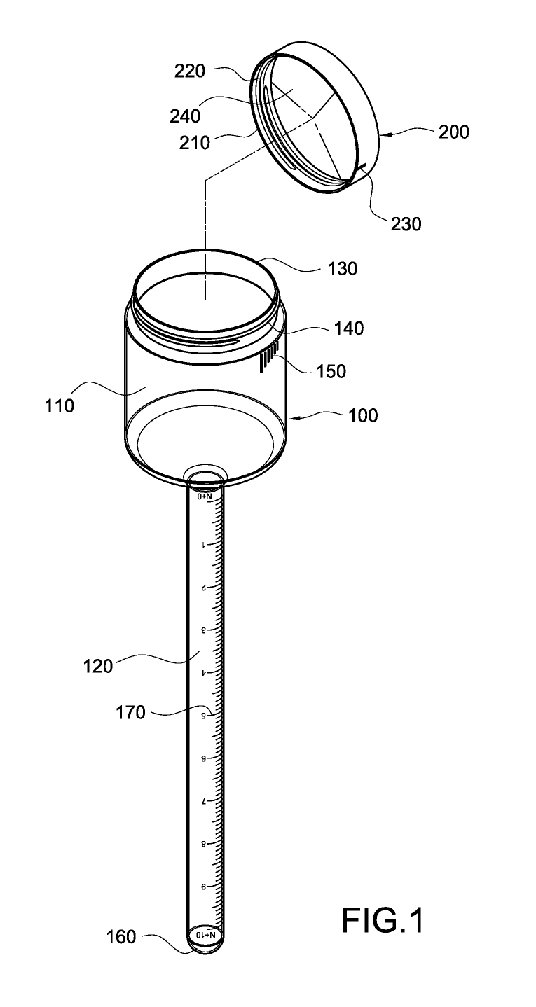

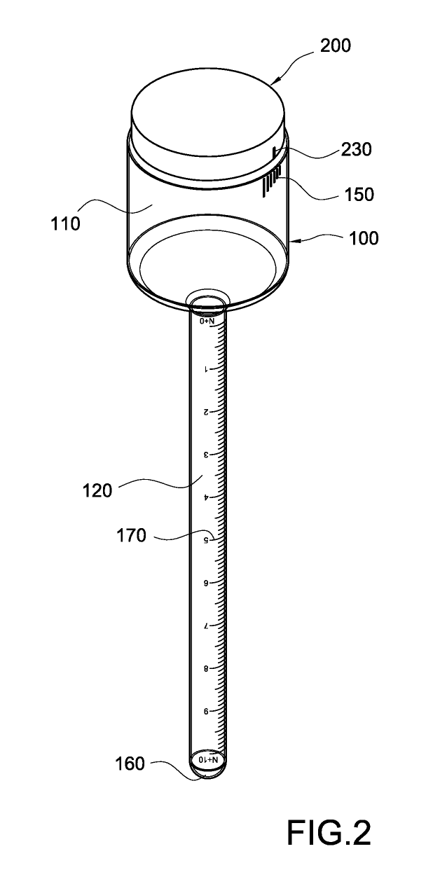

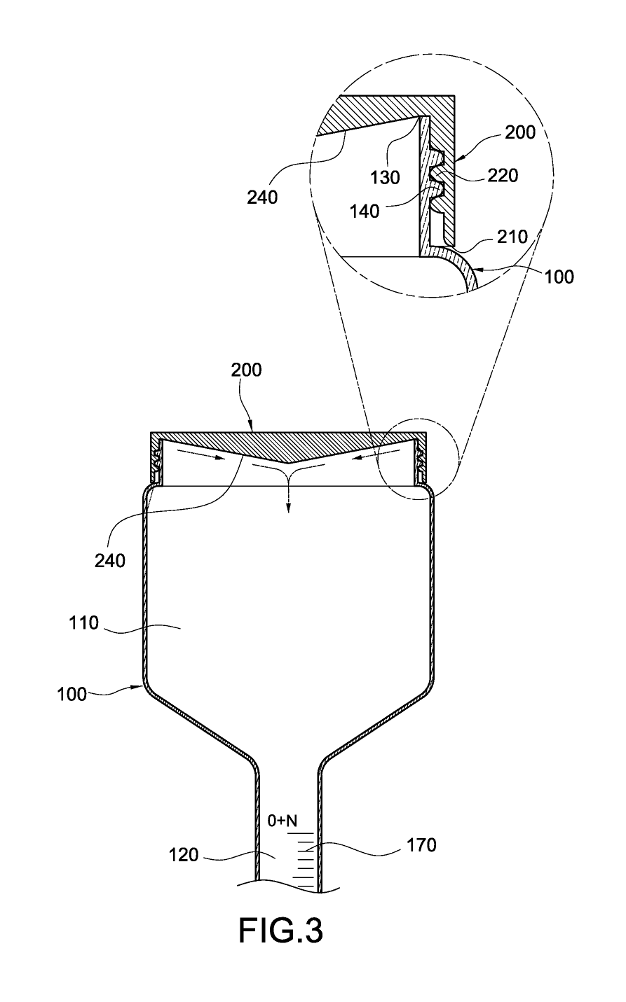

The invention is related to a special measuring bottle for measuring volume of solid, as shown in FIG. 1 through FIG. 3, including a bottle body 100 and a lid body 200.

The bottle body 100 is shown as a cylindrical shape, however, not limited to this configuration only. The internal space of the bottle body 100 is separated into an accommodating cavity 110 and a reading cavity 120 respectively. The accommodating cavity 110 and the reading cavity 120 are communicated to each other. The reading cavity 120 is disposed by being aligned to the center of the accommodating cavity 110. Regarding the bottle body 100, the size of the inner edge at the accommodating cavity 110 is larger than that at the reading cavity 120. In other words, since the bottle body 100 is shown as a cylindrical shape, the internal diameter at the accommodating cavity 110 is larger than that at the reading cavity 120. In this embodiment, the bottle body 100 at the accommodating cavity 110 is shown as a large tube shape, while the bottle body 100 at the reading cavity 120 is shown as a small tube shape.

The bottle body 100 is formed an opening 130 communicated to the accommodating cavity 110. In this case, the opening 130 is formed at one side of the accommodating cavity 110 far away the reading cavity 120. Moreover, the caliber of the opening 130 is substantially equal to the internal diameter of the accommodating cavity 110. An outer thread 140 arranged on the outer wall of the bottle body 100 close to the opening 130 is formed a spiral that starts from the opening 130 and extends toward the direction of the reading cavity 120. Meanwhile, a calibrating mark 150 is formed on the peripheral wall of the bottle body 100, which can be formed by a painting manner on the inner wall or the outer wall. Other methods to form the mark 150, such as tactile and dent of entity structures, are also adaptable.

A sealed end 160 is formed at one side of the bottle body 100 at the reading cavity 120 far away the accommodating cavity 110 and adapted for sealing the reading cavity 120, such that the bottle body 100 becomes a container with a single opening. In the meantime, a plurality of graduations 170 are arranged on the bottle body 100 at the reading cavity 120, which can be formed by a painting manner on the inner wall or the outer wall. Other methods to form the graduations 170, such as tactile and dent of entity structures, are also adaptable. These graduations 170 are designated as assessing values with specific unit. In this case, the starting point of the graduations 170 is close to the accommodating cavity 110, while the extreme point of the graduations 170 is close to the sealed end 160.

The lid body 200 is shown as a round shape, however, not limited to this configuration only. The lid body 200 seals the opening 130 as a shroud, by which the bottle body 100 is sealed. Therefore, the special measuring bottle for measuring volume of solid becomes an airtight container. On the other hand, the lid body 200 has a lid opening 210, the caliber size of which is substantially equal to that of the bottle body 100 at the opening 130. Thereby, the lid body 200 can be fitted onto the outer periphery of the bottle body 100.

An inner thread 220 arranged on the inner wall of the lid body 200 close to the lid opening 210 is formed a spiral that starts from the inner bottom wall of the lid body 200 and extends toward the direction of the lid opening 210. The inner thread 220 is adapted for an engagement with the outer thread 140. Meanwhile, a positioning mark 230 is formed on the lid wall of the lid body 200, which can be formed by a painting manner on the inner wall or the outer wall. Other methods to form the mark 230, such as tactile and dent of entity structures, are also adaptable. The positioning mark 230 is adapted to be aligned with the calibrating mark 150 for the purpose of an accurate positioning, when the lid body 200 is engaged with the bottle body 100. In this case, the calibrating mark 150 can be a plurality of lines, instead of a single line only. Thereby, the error of engaging tightness resulted from the manufacturing or using process of the measuring bottle can be rectified. In addition, a shallow cone surface 240 is formed at the inner bottom surface of the lid body 200. The structure of the shallow cone surface 240 is configured by projecting the inner wall of the lid body 200 from the outer edge and gradually converging into a tip point at the center.

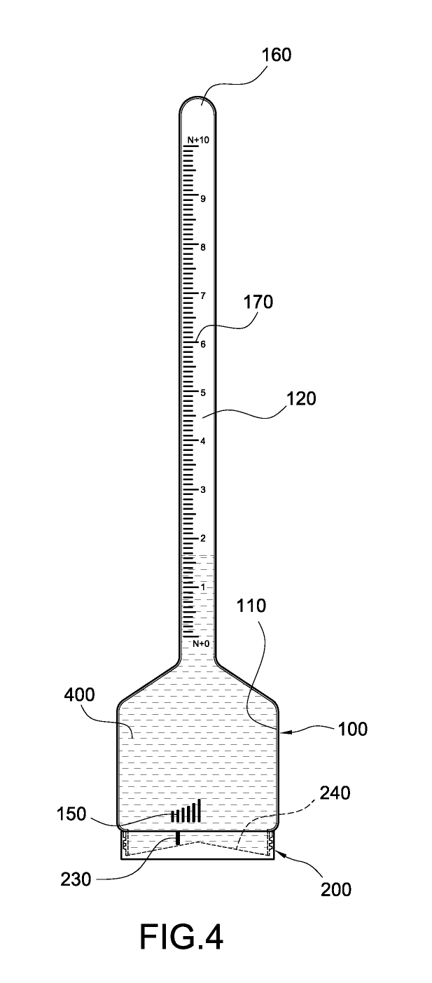

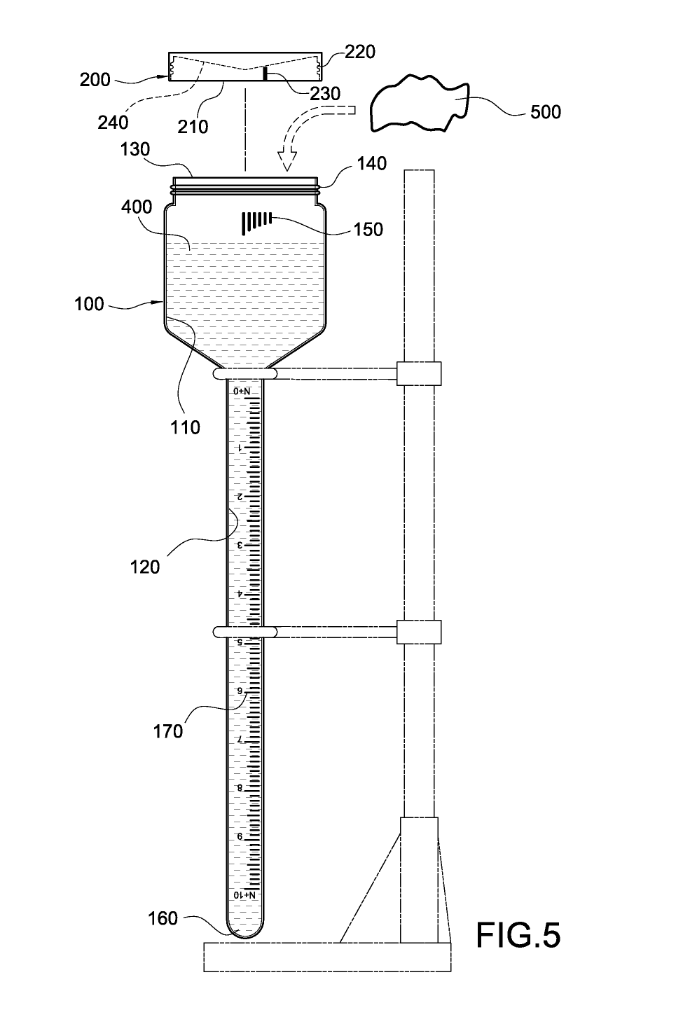

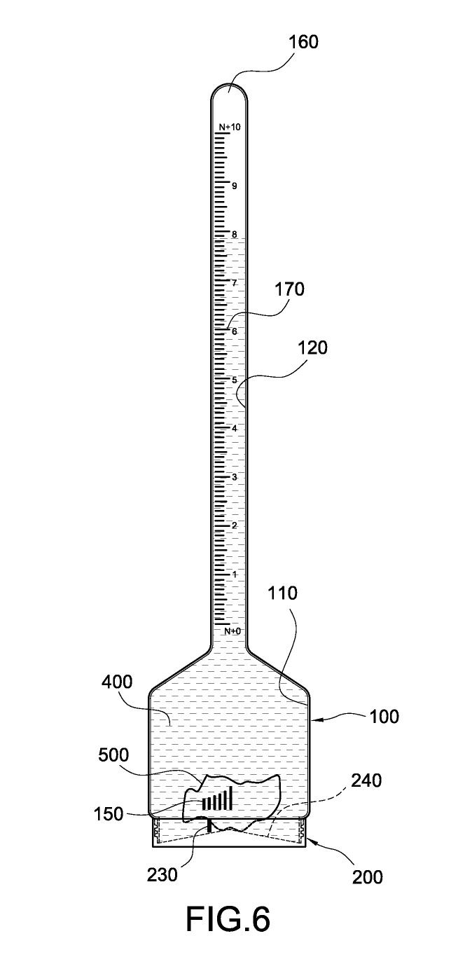

As shown in FIG. 4 through 6, the invention is a method for measuring the volume of a solid by reading the value of the graduation 170, where the level of the liquid 400 reaches. According to the method, the bottle body 100 and the lid body 200 have to be separated first to fill the liquid 400 into the bottle body 100. The bottle body 100 is disposed uprightly with the opening 130 facing upwardly and the sealed end 160 facing downwardly. Then, the liquid 400 is filled into the bottle body 100 from the opening 130. However, the bottle body 100 is not filled totally by remaining a considerable space to facilitate in placing the sample solid 500 therein. Usually, the liquid 400 adapted herein is water.

Next, the lid body 200 is adapted for sealing the opening 130. After tightening the lid body 200 onto the bottle body 100, the positioning mark 230 on lid body 200 should be aligned to the calibrating mark 150 on the bottle body 100. The bottle body 100 is then reversed with the opening 130 facing downwardly and the sealed end 160 facing upwardly. Now, the liquid level should be above the starting point of the graduations 170, but there is still a considerable space remained between the liquid level and the extreme point of the graduations 170, so a sufficient room is available for the liquid level to be lifted after the sample solid 500 is immersed into the accommodating cavity 110. If the liquid level is not within the range, the lid body 200 has to be taken off to remove or add the appropriate amount of the liquid until the liquid level is located within the range. If the liquid level is within the range, the value of the graduation 170 which the liquid level reaches reads as a reference value.

When the bottle body 100 is disposed with the opening 130 facing upwardly and the sealed end 160 facing downwardly, there is still a considerable space remained between the liquid face and the shallow cone surface 240 without being filled with the liquid 400. Therefore, acted by the gravity force, the liquid 400 remained in the bottle lid will attach at the central point of the shallow cone surface 240, instead of attaching on the bottom wall edge or inner side wall of the lid body 200. By doing so, the liquid 400 won't be lost, when the lid body 200 is taken off or put onto the opening 130.

In this embodiment, the sample solid 500 is a solid of irregular shape. Compared to the prior art, since the size of the sample solid 500 is larger than the tube diameter of the prior graduate, the sample solid 500 is unable to be placed into the graduate. In the present invention, the sample solid 500 can smoothly pass through the opening 130 and be placed into the accommodating cavity 110. After the sample solid 500 is placed therein, the lid body 200 covers onto the bottle body 100. After being tightened by rotation, the positioning mark 230 of the lid body 200 is aligned to the calibrating mark 150 on the bottle body 100. If the calibrating mark 150 is a plurality of lines, the same line has to be aligned during the two times of tightening. At this time, the container is shown as a sealed state.

The bottle body 100 is placed with the opening 130 facing downwardly and the sealed end facing upwardly, while the sample solid 500 is immersed in the accommodating cavity 110 with air floating up to the sealed end 160. Moreover, since the wall face of the bottle body 100 at the intersection between the accommodating cavity 110 and the reading cavity 120 is shown as a tilting shape, air won't be impeded thereby and can smoothly float upwardly, and hence there will be no bubble attaching to the accommodating cavity 110 to influence the measurement.

The volume of the solid immersed into the liquid is equal to the volume of the liquid the immersed solid displaces. Compared to the situation when the sample solid 500 is not immersed into the accommodating cavity 110, the liquid face of the liquid 400 is lifted toward the sealed end 160. By means of the graduations 170, the increased level of the liquid 400 in the reading cavity 120 can be read. Namely, the value of the graduation 170 which the lifted liquid level reaches deducting the original reference value is equal to the volume of the sample solid 500.

Compared to the prior graduate, the size of the inner edge of the reading cavity 120 is small enough to make the lifting of the liquid face react sensitively. Namely, the present invention has a higher accuracy of measurement. In addition, the size of the inner edge of the accommodating cavity 110 is large enough to accommodate a sample solid 500 with relatively large volume. In the meantime, the sample solid 500 will float upwardly, if the specific weight of the solid is less than that of the liquid. In this case, the size of the sample solid 500 is too large to float upward into the reading cavity 120, so the sample solid 500 is retained in the accommodating cavity 100. In other words, by means of the present invention, the volume of a solid whose specific weight is less than the liquid 400 can be measured correctly.

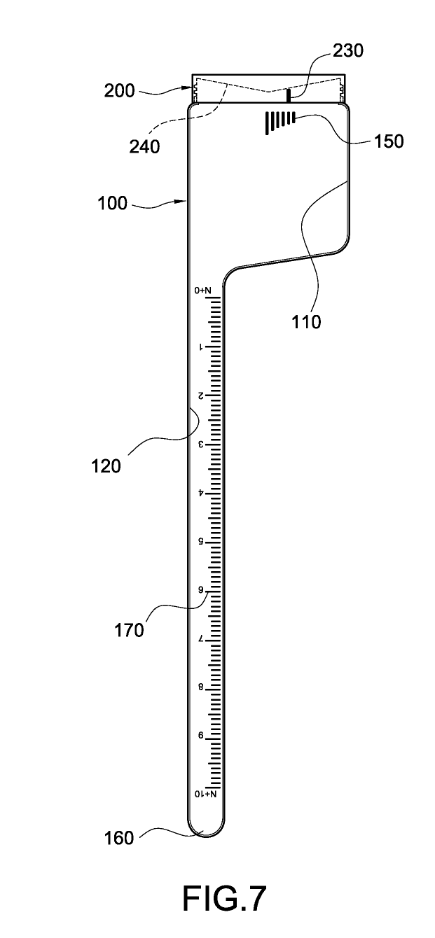

Please refer to FIG. 7. The reading cavity 120 can also be arranged at lateral side of the accommodating cavity 110. In other words, the reading cavity 120 can be disposed at any position, as long as it is communicated to the accommodating cavity 110.

Therefore, through the constitution of aforementioned assemblies, a special measuring bottle for measuring volume of solid according to the present invention is thus obtained.

Summarizing aforementioned description, the special measuring bottle according to the present invention is an indispensable device for measuring volume of solid indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A special measuring bottle for measuring volume of solid, including:
a bottle body, which is provided to be filled with a liquid and has an accommodating cavity to be accommodated with a sample solid and a reading cavity arranged a plurality of graduations available for reading a level position of the liquid and communicating with the accommodating cavity, a size of an inner edge of which is larger than that of the reading cavity, and which is formed an opening to let the sample solid pass through; and
a lid body, which is sealed at the opening as a shroud.

2. The special measuring bottle for measuring volume of solid according to claim 1, wherein the bottle body is formed with a calibrating mark, corresponding to which the lid body is formed with a positioning mark.

3. The special measuring bottle for measuring volume of solid according to claim 1, wherein the bottle body is shown as a cylindrical shape.

4. The special measuring bottle for measuring volume of solid according to claim 3, wherein the bottle body is formed with an external thread, engaged with which an internal thread is formed on a peripheral wall of the lid body.

5. The special measuring bottle for measuring volume of solid according to claim 1, wherein a shallow cone surface is formed at an inner bottom wall of the lid body.
